(19) United States
(12) Patent Application Publication
(10) Pub. No.: US 2026/0277562 A1
(43) Pub. Date: Sep. 17, 2026

(54) LARGE LANGUAGE MODEL BASED DRIVER CODE GENERATOR FOR SYSTEMS HAVING A UNIFIED EXTENSIBLE FIRMWARE INTERFACE

(71) Applicant: Lenovo Global Technology (United States) Inc., Morrisville, NC (US)

(72) Inventors: Swastik Ghosh, Raleigh, NC (US); James G. McLean, Raleigh, NC (US)

(21) Appl. No.: 19/079,555

(22) Filed: Mar. 14, 2025

(51) Int. Cl. G06F 8/35; G06N 3/0895

(52) U.S. Cl. CPC G06F 8/35; G06N 3/0895

(57) ABSTRACT

A management controller receives a message from a Unified Extensible Firmware Interface (UEFI) on a first computing node identifying a hardware device for which the UEFI is missing driver code, wherein the UEFI is unable to initialize the hardware device without the missing driver code. The management controller sends a prompt to a driver code generating service requesting generation of new driver code for the identified hardware device. The driver code generating service includes a large language model (LLM) for generating new driver source code and a code compiler for compiling the new driver source code to form new driver binary code. The management controller receives the new driver binary code from the driver code generating service and causes the new driver binary code to be loaded into the UEFI, wherein the UEFI is able to use the new driver binary code to initialize the hardware device.

### BACKGROUND

The present disclosure relates to systems and methods for responding to a Unified Extensible Firmware Interface that is missing driver code needed to initialize a hardware device.

### BACKGROUND OF THE RELATED ART

The Unified Extensible Firmware Interface (UEFI) is firmware that is stored on a motherboard and includes code that is run by the central processing unit when the computing device is first powered on and before starting the operating system. The UEFI includes a mechanism for interacting with and initializing underlying hardware, known as the Driver Execution Environment (DxE) phase. Typically, the UEFI can load a firmware image from a hardware device, bind DxE driver code to firmware image, and initialize the hardware device for the operating system. However, if a hardware device has a firmware image but the UEFI does not have driver code corresponding to the same hardware device, the UEFI will usually return an error indicating that the hardware device could not be initialized. In such cases, manual interventions are necessary to get the UEFI to recognize and initialize the hardware.

Initializing a hardware device for an operating system involves setting up the basic configuration of the hardware device, including identifying its type and capabilities, establishing communication channels, setting default values for its registers, allocating memory addresses for the device to access data, setting power states and management options for the device, and/or configuring interrupt handling mechanisms, essentially preparing the hardware device to be accessed and used by the operating system through dedicated device drivers. This process often happens during the computer's boot sequence, managed by the UEFI firmware

### BRIEF SUMMARY

Some embodiments provide a computer program product comprising a non-transitory computer readable storage medium and program instructions embodied therein, the program instructions being configured to be executable by a processor of a management controller in a server to cause the processor to perform various operations. The operations comprise receiving a message from Unified Extensible Firmware Interface code on a first computing node, wherein the message identifies a hardware device installed within the first computing node for which the Unified Extensible Firmware Interface code is missing driver code, and wherein the Unified Extensible Firmware Interface code is unable to initialize the hardware device to an operating system of the first computing node without the missing driver code. The operations further comprise sending a prompt to a driver code generating service requesting the driver code generating service generate new driver code for the identified hardware device, wherein the driver code generating service includes a large language model for generating new driver source code and a code compiler for compiling the new driver source code to form new driver binary code. Still further, the operations comprise receiving the new driver binary code from the driver code generating service and causing the new driver binary code to be loaded into the Unified Extensible Firmware Interface code, wherein the Unified Extensible Firmware Interface code is able to use the new driver binary code to initialize the hardware device to the operating system.

Some embodiments provide a method comprising various operations. The operations comprise a management controller receiving a message from Unified Extensible Firmware Interface code on a first computing node, wherein the message identifies a hardware device installed within the first computing node for which the Unified Extensible Firmware Interface code is missing driver code, and wherein the Unified Extensible Firmware Interface code is unable to initialize the hardware device to an operating system of the first computing node without the missing driver code. The operations further comprise the management controller sending a prompt to a driver code generating service requesting the driver code generating service generate new driver code for the identified hardware device, wherein the driver code generating service includes a large language model for generating new driver source code and a code compiler for compiling the new driver source code to form new driver binary code. Still further, the operations comprise the management controller receiving the new driver binary code from the driver code generating service, and the management controller causing the new driver binary code to be loaded into the Unified Extensible Firmware Interface code, wherein the Unified Extensible Firmware Interface code is able to use the new driver binary code to initialize the hardware device to the operating system.

Some embodiments provide a computer program product comprising a non-transitory computer readable storage medium and program instructions embodied therein, the program instructions being configured to be executable by a processor to cause the processor to perform various operations. The operations comprise loading a large language model that has been trained to generate driver source code for use by Unified Extensible Firmware Interface code to initialize a hardware device within a computing node, receiving a prompt requesting driver source code for an identified hardware device, and causing the trained large language model to generate the driver source code for the identified hardware device.

### BRIEF DESCRIPTION OF THE SEVERAL VIEWS OF THE DRAWINGS

FIG. 1 is a diagram of a system using a trained large language model to generate driver code for a hardware device of a computing node in response to detecting that the driver code is missing.

FIG. 2 is a diagram of a computer or server according to some embodiments.

FIG. 3 is a diagram of a baseboard management controller according to some embodiments.

FIG. 4 is a flowchart of operations performed by a baseboard management controller according to some embodiments.

FIG. 5 is a flowchart of operations performed by a driver code generating service according to some embodiments.

### DETAILED DESCRIPTION

Some embodiments provide a system. The system comprises a first computing device having a Unified Extensible Firmware Interface, an operating system, a management controller, and a hardware device, wherein the Unified Extensible Firmware Interface requires driver code to initialize the hardware device to the operating system. The system further comprises a second computing device including a large language model trained to generate new driver source code for identified hardware devices and a compiler for compiling the new driver source code to form new driver binary code, wherein the first computing device is in communication via a network with the second computing device for sending a prompt from the management controller to the large language model requesting that the large language model generate missing driver source code for the hardware device. Optionally, the large language model and the compiler may form, or be included in, a driver code generating service.

The first computing device is an individual computing node, such as a server. The Unified Extensible Firmware Interface (UEFI) is firmware that is stored on a motherboard and includes code that is run by the central processing unit when the computing device is first powered on and before starting the operating system. UEFI is an open standard that replaced the Basic Input Output System (BIOS) and overcomes various BIOS restrictions, such as addressable memory restrictions. UEFI firmware code plays a critical role in initializing server hardware devices and establishing a bridge between the hardware devices and the operating system (OS). When a server is powered on, the UEFI firmware performs a Power-On Self-Test (POST) to check hardware components, initializes processors, memory, and storage controllers, and then locates the bootloader from a designated boot device using the UEFI Boot Manager. The bootloader is then executed to load the OS kernel into memory. Importantly, UEFI stores all data about initialization and startup in an *.efi file, instead of storing it on the firmware as was done by the BIOS. This *.efi file is stored on a special partition called EFI System Partition (ESP) on the hard disk. This ESP partition also contains the bootloader.

The management controller may be an embedded controller or a baseboard management controller. An embedded controller is a specialized computer chip that manages specific functions. The baseboard management controller is a dedicated microcontroller on a server's motherboard that supports remote monitoring and management of a server's hardware even when the operating system is not running. Accordingly, an embedded controller may focus on localized or specialized control within a device, whereas a baseboard management controller provides system-wide management capabilities for a server or other computing device.

The hardware device of the first computing device may be any of a plurality of hardware devices that may be implemented in various configurations of a computing device. For example, where the computing device is a server, the server may include hardware devices that include, without limitation, a central processing unit (CPU), memory, data storage devices, a power supply, a network interface controller, and perhaps a graphic processing unit (GPU). Many of these hardware devices may have their own firmware stored on, or in close association with, the hardware device itself. For example, firmware stored on hard drives and solid state drives may manage data access and error correction, firmware stored on a network interface card may control network communication protocols and settings, and firmware on a graphics card may manage video output settings and functionality of the graphics card. Some of these hardware devices may reside directly on the motherboard and others may take the form on an expansion card, yet the UEFI is responsible for initializing all of these hardware devices to the operating system.

For some of the hardware devices, the UEFI will run small pieces of code, known as drivers, that manage hardware devices during the pre-boot phase of a computer startup. Accordingly, the UEFI provides a platform to execute these drivers and initialize the hardware devices before handing over control to the operating system. However, each hardware device may require separate driver code that is written specifically for that hardware device. The driver code for an individual hardware device may be initially prepared as driver source code, which is the human-readable text written by a programmer in a programming language. However, the UEFI actually executes driver binary code, which is the machine-readable code consisting of 0 s and 1 s that is formed by compiling the source code.

The second computing device may be one or more servers in the same local area network as the first computing device or in a remote network accessible over a wide area network, such as the Internet. Alternatively, the second computing device may be part of a cloud computing environment. Accordingly, the second computing device hosts the large language model (LLM) and the compiler, such as where the large language model and the compiler are cloud-based services. The management controller on the first computing device may send a prompt to the large language model on the second computing device or system over one or more networks, including the Internet, requesting that the large language model generate missing driver source code for the hardware device.

Training a large language model (LLM) for a specific task requires a training dataset that provides the raw data necessary for the model to learn patterns, relationships, and contextual meanings. The training dataset must be curated to align with the desired task, such as the generation of missing driver source code for the hardware device. The training dataset is then preprocessed, perhaps including cleaning the text, tokenizing words, and structuring the dataset into a format suitable for training. During training, the LLM uses machine learning techniques, such as machine learning techniques for deep learning architectures like transformers, to analyze vast amounts of text and adjust the model's parameters through iterative optimization methods such as gradient descent. The model learns by predicting text sequences, minimizing errors, and refining its understanding based on the dataset's examples. Optionally, a pre-trained LLM may be fine-tuned by further training on specialized datasets to tailor the model's performance for a particular application, ensuring it can generate accurate, context-aware, and coherent responses (i.e., driver source code). It should be understood that the generated driver source code may not be identical to driver source code that might be provided by the manufacturer of the hardware device. Still, the driver source code generated by the LLM is preferably suitable to support some or all of the functionality of the hardware device and/or to enable the UEFI to proceed with its execution flow.

In some embodiments, the large language model has been, or will be, trained to generate driver source code using various datasets. Without limitation, these training datasets may include datasheets and reference manuals of the silicon components of the hardware device, such as an integrated circuit or semiconductor chip, that require a driver. The training dataset may further include reference code from one or more hardware vendors, driver source code for other hardware devices that have similar functionality, driver source code from the same vendor for other hardware components, and/or UEFI EDK2 (“Unified Extensible Firmware Interface Development Kit version 2”) codebase containing the driver model and code structure. UEFI EDK2 is an open-source, cross-platform development environment used to create firmware applications for the UEFI standard, essentially providing a robust set of tools to build and customize the low-level software that runs on your computer before the operating system boots up.

In some embodiments, the system may further comprise a code database that is accessible to the management controller of the first computing node. For example, the code database may be a local code database that stores driver source code and/or driver binary code for a plurality of hardware devices. The code database forms a resource where missing driver code may be obtained. However, any driver code that is missing from the UEFI may also be missing from the code database. Accordingly, the code databased may provide an efficient source of some missing driver code but does not eliminate the need for the large language model and compiler. In one option, any driver source code generated by the large language model and any driver binary code formed by the compiler for use by the UEFI of a particular computing device may also be stored in the code database for subsequent use. Therefore, if the UEFI of another computing device is missing driver code for another unit of the same hardware device, then the missing driver code can be obtained from the code database rather than prompting the large language model to generate the missing driver code.

Some embodiments provide a method performed by the system. The method comprises Unified Extensible Firmware Interface (UEFI) code on a first computing node determining that driver code for a hardware device installed within the first computing node is missing, wherein the Unified Extensible Firmware Interface code is unable to initialize the hardware device to an operating system of the first computing node without the missing driver code. The method further comprises the Unified Extensible Firmware Interface code sending a message to a management controller internal to the first computing node, wherein the message identifies the hardware device for which the Unified Extensible Firmware Interface code is missing the driver code. Still further, the method comprises the management controller sending a prompt to a large language model to generate new driver source code for the identified hardware device, the large language model generating the new driver source code and providing the new driver source code to a code compiler, and the code compiler compiling the new driver source code to form new driver binary code. The method also comprises causing the new driver binary code to be loaded into the Unified Extensible Firmware Interface code, and the Unified Extensible Firmware Interface code using the new driver binary code to initialize the hardware device to the operating system.

In some embodiments, the new driver binary code is dynamically loaded into the Unified Extensible Firmware Interface code to support initialization of the hardware device without returning an error. In other words, the new driver binary code may be provided to the UEFI in real-time during the startup on the first computing device in response to the UEFI detecting that the driver code for a particular hardware device is missing. In one option, the Unified Extensible Firmware Interface code proceeds with regular Unified Extensible Firmware Interface code execution flow after loading the new driver binary code.

In some embodiments, the new driver binary code generated by the compiler is initially provided to the management controller and then the management controller causes the new driver binary code to be loaded into the Unified Extensible Firmware Interface code. For example, a baseboard management controller is fully functional even when the first computing device is powered off or not yet fully booted and has network access to support communication with the large language model and the associated compiler.

In some embodiments, the method may further comprise the management controller sending a prompt to a code database searching for the missing driver code and then downloading the missing driver code from the code database and sending the missing driver code to the Unified Extensible Firmware Interface code. The Unified Extensible Firmware Interface may then install the missing driver code into the Unified Extensible Firmware Interface code and initialize the hardware device to the operating system of the first computing node using the installed driver code. Furthermore, the management controller may send the prompt to the large language model in response to the management controller determining that the code database does not contain the missing driver code. Still further, if the code database contained the driver source code but not the driver binary code, the management controller may cause the compiler to form the new driver binary code using the driver source code such that the management controller may subsequently provide the new driver binary code to the UEFI.

In some embodiments of the system that include a code database, the method may further comprise storing the new driver source code and/or the new driver binary code in the code database that is accessible to the management controller of the first computing node. Accordingly, if the UEFI of one or more computing devices identify that they are missing driver code for a hardware device of the same type, then the missing driver code may be obtained from the code database rather than prompting the large language model to generate the missing driver code.

In some embodiments, the method may further comprise training the large language model to generate driver source code. For example, the large language model may be trained using datasets including, without limitation, datasheets and reference manuals of the silicon components of the hardware device, such as an integrated circuit or semiconductor chip, that require a driver. The training dataset may further include reference code from one or more hardware vendors, driver source code for other hardware devices that have similar functionality, driver source code from the same vendor for other hardware components, and/or UEFI EDK2 (“Unified Extensible Firmware Interface Development Kit version 2”) codebase containing the driver model and code structure.

Training an AI model involves exposing the AI model to a dataset so the AI model can learn patterns and relationships within the data. This process typically begins with initializing the model's parameters, such as weights in a neural network. The model then processes the dataset, making predictions and comparing them to the actual outputs. Using an optimization algorithm like gradient descent, the model adjusts its parameters iteratively to minimize the error between its predictions and the correct answers. Over time, as the model refines these parameters, it becomes better at recognizing patterns and generalizing to new inputs. Once trained, the model can generate output in response to a given prompt by applying the learned parameters to process and interpret the input, producing responses that align with the patterns it identified during training. In the present embodiments, the AI model is a large language model that is trained to output driver source code in response to a prompt containing the identity of a hardware device for which the driver source code is needed.

In some embodiments, the large language model generates the driver source code including a code portion that provides stub functionality for one or more functions of the hardware device but enables the computing node to boot. As used herein, “stub functionality” refers to simulated behavior of the missing functionality that provides a minimal functionality, such as returning a default value, that enables a program to complete execution. In the present context, driver source code with stub functionality does not enable the full functionality of the hardware device, but it at least sufficient for the UEFI to proceed with its regular code execution flow. In one option, the large language model may generate the driver source code including a first code portion that implements full functionality of a first subset of capabilities of the hardware device and a second code portion that implements stub functionality of a second subset of capabilities of the hardware device.

In some embodiments, the Unified Extensible Firmware Interface code may be customized to ignore an error or warning resulting from executing the new driver binary code in response to detecting that the new driver binary code was generated by the large language model. In other words, the UEFI may overlook certain problems with executing a new driver binary code if the circumstances (i.e., the new driver binary code originates from the large language model) indicate that this new driver binary code is a temporary remedy or patch.

Some embodiments provide a computer program product comprising a non-transitory computer readable storage medium and program instructions embodied therein, the program instructions being configured to be executable by a processor of a management controller in a server to cause the processor to perform various operations. The operations comprise receiving a message from Unified Extensible Firmware Interface code on a first computing node, wherein the message identifies a hardware device installed within the first computing node for which the Unified Extensible Firmware Interface code is missing driver code, and wherein the Unified Extensible Firmware Interface code is unable to initialize the hardware device to an operating system of the first computing node without the missing driver code. The operations further comprise sending a prompt to a driver code generating service requesting the driver code generating service generate new driver code for the identified hardware device, wherein the driver code generating service includes a large language model for generating new driver source code and a code compiler for compiling the new driver source code to form new driver binary code. Still further, the operations comprise receiving the new driver binary code from the driver code generating service and causing the new driver binary code to be loaded into the Unified Extensible Firmware Interface code, wherein the Unified Extensible Firmware Interface code is able to use the new driver binary code to initialize the hardware device to the operating system.

In some embodiments, the operations performed by the management controller may further comprise sending a prompt or query to a code database searching for the missing driver code. Such a prompt may include the identity of the missing driver code, or the identity of the hardware device associated with the missing driver code. The operations may further comprise downloading, in response to the code database having matching driver code for the hardware device, the matching driver code from the local source code database and causing the matching driver binary code to be loaded into the Unified Extensible Firmware Interface code. The Unified Extensible Firmware Interface code should then be able to use the matching driver code to initialize the hardware device to the operating system. In one option, the prompt to the driver code generating service is sent in response to the code database not having matching driver code for the hardware device.

Some embodiments provide a method comprising various operations. The operations comprise a management controller receiving a message from Unified Extensible Firmware Interface code on a first computing node, wherein the message identifies a hardware device installed within the first computing node for which the Unified Extensible Firmware Interface code is missing driver code, and wherein the Unified Extensible Firmware Interface code is unable to initialize the hardware device to an operating system of the first computing node without the missing driver code. The operations further comprise the management controller sending a prompt to a driver code generating service requesting the driver code generating service generate new driver code for the identified hardware device, wherein the driver code generating service includes a large language model for generating new driver source code and a code compiler for compiling the new driver source code to form new driver binary code. Still further, the operations comprise the management controller receiving the new driver binary code from the driver code generating service, and the management controller causing the new driver binary code to be loaded into the Unified Extensible Firmware Interface code, wherein the Unified Extensible Firmware Interface code is able to use the new driver binary code to initialize the hardware device to the operating system.

Some embodiments provide a computer program product comprising a non-transitory computer readable storage medium and program instructions embodied therein, the program instructions being configured to be executable by a processor to cause the processor to perform various operations. The operations comprise loading a large language model that has been trained to generate driver source code for use by Unified Extensible Firmware Interface code to initialize a hardware device within a computing node, receiving a prompt requesting driver source code for an identified hardware device, and causing the trained large language model to generate the driver source code for the identified hardware device. Without limitation, the processor may be part of a standalone server or a server in a cloud environment. Optionally, the computer program product may be part of a driver code generating service that is hosted in a cloud-computing environment.

In some embodiments, the operations performed by a process executing the program instructions may further comprise training the large language model to generate driver source code. For example, the large language model may be trained using datasets including, without limitation, datasheets and reference manuals of the silicon components of the hardware device, such as an integrated circuit or semiconductor chip, that require a driver. The training dataset may further include reference code from one or more hardware vendors, driver source code for other hardware devices that have similar functionality, driver source code from the same vendor for other hardware components, and/or UEFI EDK2 (“Unified Extensible Firmware Interface Development Kit version 2”) codebase containing the driver model and code structure.

In some embodiments, the operations may further comprise storing, for each of a plurality of instances of driver source code generated by the large language model, the generated driver source code in association with an identifier for a device, such as the baseboard management controller, that submitted the prompt requesting the driver source code. The operations may further comprise receiving feedback from the device that submitted the prompt, wherein the feedback indicates that the generated driver source code did not enable the UEFI to initialize the hardware device, causing the large language model to regenerate the driver source code. In other words, if the generated driver source code did not lead to driver binary code that was successfully used to initialize the intended hardware device, then the large language mode may regenerate the driver source code. In one option, the large language model may regenerate the drive source code using different prompt values than in the received prompt. In another option, the large language model may be retrained in response to receiving the feedback, wherein the large language model regenerates the driver source code subsequent to the retraining of the large language model.

In some embodiments, the operations may further comprise providing the new driver source code to a code compiler for compiling the new driver source code to form new driver binary code. It is the new driver binary code that is provided to the UEFI.

In some embodiments, the large language model generates the driver source code including a code portion that provides stub functionality for one or more functions of the hardware device but the corresponding driver binary code will enable the computing node to boot. In one option, the large language model may generate the driver source code including a first code portion that implements full functionality of a first subset of capabilities of the hardware device and a second code portion that implements stub functionality of a second subset of capabilities of the hardware device.

Embodiments provide a custom modification in the UEFI code such that the UEFI's response to missing driver code is to send a message to the management controller of the same computing node requesting the missing driver code for a particular hardware device rather than simply failing to initializing the hardware device and returning an error. The management controller may first check a driver code database to determine whether the missing driver code is available in the driver code database for downloading and installation into the UEFI code. However, if the driver code is missing from the driver code database or if no driver code database is provided, then the management controller may connect to a cloud-based driver code generating service including a Large Language Model (LLM) that is trained to generate UEFI driver source code. Once the LLM has generated the needed driver source code, the LLM provides the driver source code to a cloud-based compiler and the cloud-based compiler compiles the driver source code to form the driver binary code. The driver source code generated by the LLM and the driver binary code formed by the compiler are then sent to the management controller and stored in the driver code database for future reference.

The foregoing computer program products may further include program instructions for implementing or initiating any one or more operations of the methods described herein. Conversely, the foregoing methods may include operations performed by processors executing the program instructions described herein. Still further, computer program products and methods may make use of any part of the systems described herein, and the systems may be used in the operations according to the computer program products and methods described herein.

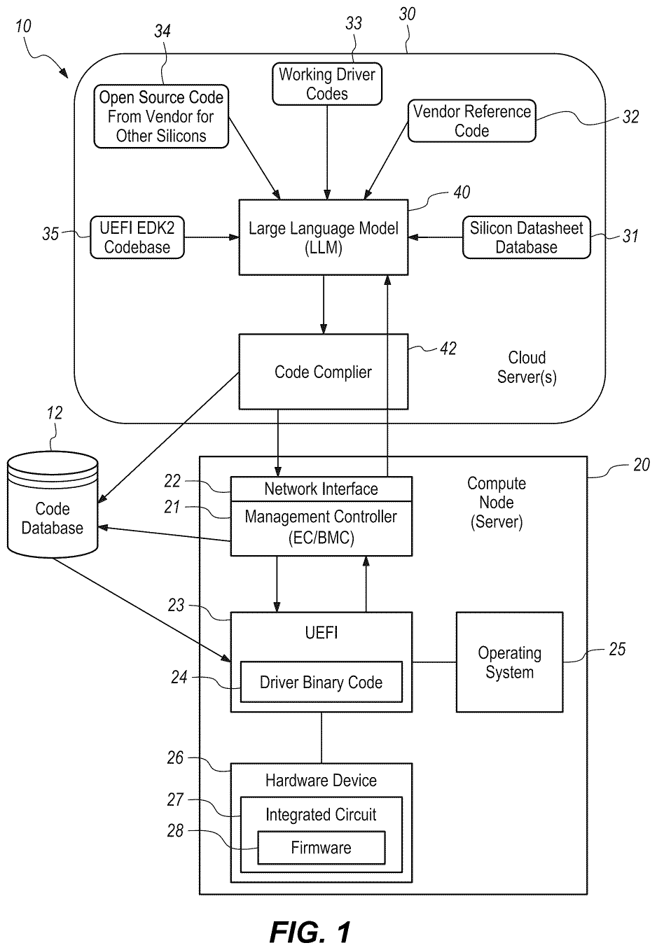

FIG. 1 is a diagram of a system 10 using a trained large language model 40 to generate driver source code for a hardware device 26 of a computing node (server) 20 in response to detecting that the UEFI 23 is missing driver code for the hardware device 26. The system 10 includes at least one first computing node or device 20 having a Unified Extensible Firmware Interface 23, an operating system 25, a management controller 21, and a hardware device 26, wherein the Unified Extensible Firmware Interface 23 requires driver binary code 24 to initialize the hardware device 26 to the operating system 25. In one example, the hardware device 26 include an integrated circuit 27 with firmware 28 that affects the functioning of the hardware device. For example, firmware stored on a hard drive or solid state drive may manage data access and error correction, firmware stored on a network interface card may control network communication protocols and settings, and firmware on a graphics card may manage video output settings and functionality of the graphics card.

The system 10 further comprises a second computing device 30 including a large language model 40 trained to generate new driver source code for identified hardware devices and a compiler 42 for compiling the new driver source code to form new driver binary code. The second computing device 30 may be one or more servers in the same local area network as the first computing device 20 or in a remote network accessible over a wide area network, such as the Internet. Alternatively, the second computing device 30 may be part of a cloud computing environment hosting both the large language model (LLM) and the compiler, such as where the large language model and the compiler are cloud-based services, perhaps collectively forming or include in a driver code generating service. The management controller 21 on the first computing device 20 may use a network interface 22 to send a prompt to the large language model 40 on the second computing device or system 30 over one or more networks, including the Internet, requesting that the large language model 40 generate missing driver source code for the hardware device 26.

Training the large language model (LLM) 40 for a specific task requires a training dataset that provides the raw data necessary for the model to learn patterns, relationships, and contextual meanings. The large language model 40 has been, or will be, trained to generate driver source code using various datasets, such as datasheets and reference manuals 31 of the silicon components of the hardware device, such as an integrated circuit or semiconductor chip, that require a driver. The training dataset may further include reference code 32 from one or more hardware vendors, driver source code 33 for other hardware devices that have similar functionality, driver source code 34 from the same vendor for other hardware components, and/or UEFI EDK2 (“Unified Extensible Firmware Interface Development Kit version 2”) codebase 35 containing the driver model and code structure.

The system 10 further includes a code database 12 that is accessible to the management controller 21 of the first computing node 20 with further optional direct accessibility to the UEFI 23 and the code compiler 42 (or other module of the code generating service). The code database may store driver source code and/or driver binary code for a plurality of hardware devices.

It should be understood that system 10 may include a large number of compute nodes (servers) similar to the first computing device or compute node (server) 20 with similar functionality and similar access to the second computing device 30, including the large language model 40 and compiler 42, as well as the code database 12 (if provided).

The system 10 may be used to provide driver binary code to the UEFI 23 for one or more hardware components 26. The UEFI 23 is customized to identifies missing driver binary code 24 for the hardware device 26 and, instead of returning an error, sends a message or request to the management controller 21. The management controller 21 then sends a prompt or query to the code database 12 to determine whether the missing driver binary code is available in the code database 12. If a match is found, then the matching driver binary code is sent to the UEFI 23 and loaded as a UEFI driver.

In case the missing driver binary code is not found in the code database 12 or the system 10 does not include a code database 12, then the management controller 21 sends a prompt to the LLM 40 to generate driver source code for the identified hardware device 26. The generated source code is then provided to the code compiler 42 to generate the driver binary code from the generated driver source code. The driver binary code is sent to the management controller 21 and then provided to the UEFI to be dynamically loaded into the UEFI code. The UEFI code then uses the driver binary code (newly compiled binaries) to begin initializing the hardware device and proceed with the regular code execution flow. The driver binary code, and preferably also the driver source code, may also be stored in the code database 12 and referenced for future instances that the driver code is required for another unit of the same hardware device in the same or different compute node 20.

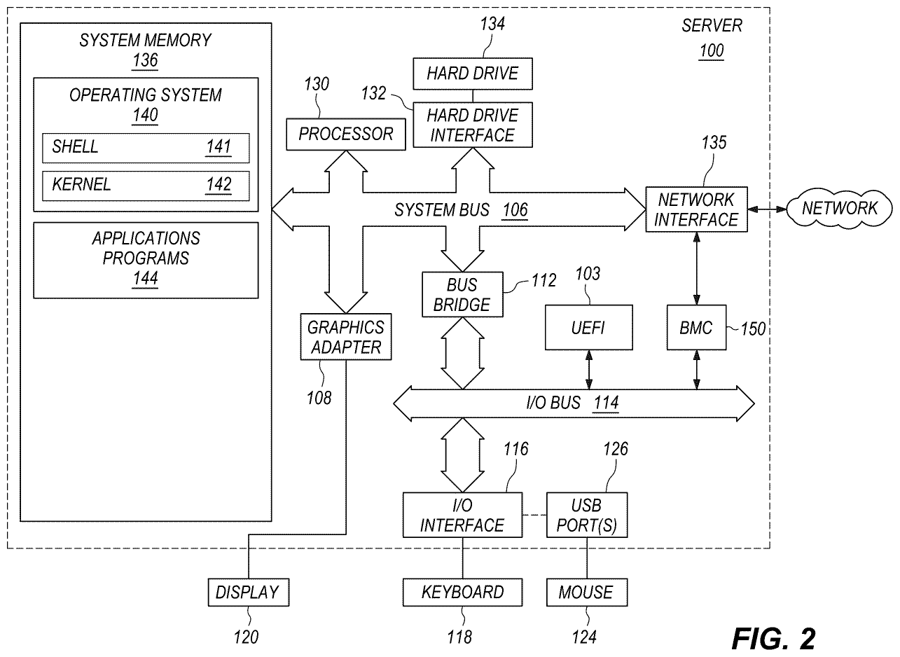

FIG. 2 is a diagram of a computer or server 100 that may be representative of any of a plurality of first computing devices or servers 20 or a second computing node 30 hosting the large language model 40 and compiler 42 as shown in FIG. 1. The server 100 includes a processor unit 130 that is coupled to a system bus 106. The processor unit 130 may utilize one or more processors, each of which has one or more processor cores. An optional graphics adapter 108, which may drive/support an optional display 120, is also coupled to system bus 106. The graphics adapter 108 may, for example, include a graphics processing unit (GPU). The system bus 106 may be coupled via a bus bridge 112 to an input/output (I/O) bus 114. An I/O interface 116 is coupled to the I/O bus 114, where the I/O interface 116 affords a connection with various optional I/O devices, such as a keyboard 118 (such as a touch screen virtual keyboard), and a USB mouse 124 via USB port(s) 126 (or other type of pointing device, such as a trackpad). As depicted, the computer 100 is able to communicate with other network devices over a network using a network adapter or network interface controller 135.

A hard drive interface 132 is also coupled to the system bus 106. The hard drive interface 132 interfaces with a hard drive 134. In a preferred embodiment, the hard drive 134 may communicate with system memory 136, which is also coupled to the system bus 106. The system memory may be volatile or non-volatile and may include additional higher levels of volatile memory (not shown), including, but not limited to, cache memory, registers and buffers. Data that populates the system memory 136 may include the operating system (OS) 140 and application programs 144. The hardware elements depicted in the server 100 are not intended to be exhaustive but rather are representative.

The operating system 114 includes a shell 141 for providing transparent user access to resources such as application programs 144. Generally, the shell 141 is a program that provides an interpreter and an interface between the user and the operating system. More specifically, the shell 141 may execute commands that are entered into a command line user interface or from a file. Thus, the shell 141, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 141 may be a text-based, line-oriented user interface, the present invention may support other user interface modes, such as graphical, voice, gestural, etc.

As depicted, the operating system 140 also includes the kernel 142, which includes lower levels of functionality for the operating system 140, including providing essential services required by other parts of the operating system 140 and application programs 144. Such essential services may include memory management, process and task management, disk management, and mouse and keyboard management. In addition, the computer server 100 may include application programs 144 stored in the system memory 136.

The server 100 may further include a baseboard management controller (BMC) 150, which may be located on a motherboard along with the processor 130. The BMC may be used to perform out-of-band processing and may monitor and manage various hardware devices of the server 100. However, the BMC may also communicate with various network devices outside the server 100 via the network interface 135. Furthermore, the server 100 includes a Unified Extensible Firmware Interface (UEFI) flash 103. For example, the UEFI flash 103 may store the driver binary code that the UEFI binds to a firmware image when initializing a hardware device for the operating system 140. The illustrated components of the server 100 are representative and should not be interpreted as limiting.

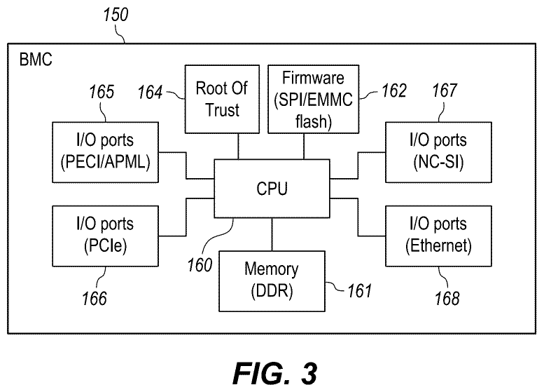

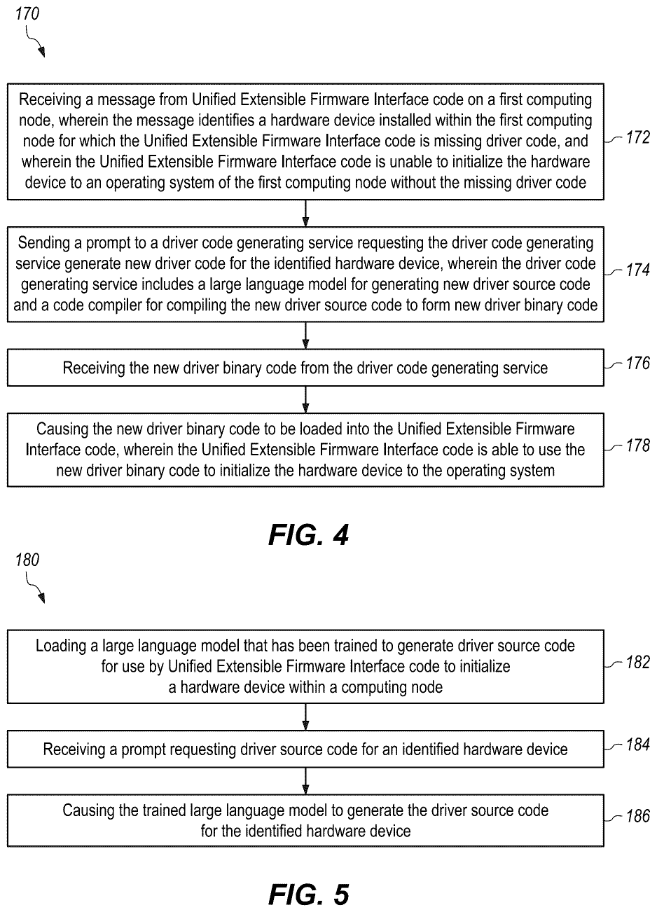

FIG. 3 is a diagram of a baseboard management controller (BMC) 150 according to some embodiments. The BMC 150 is similar to a small computer or system on a chip (SoC), including a central processing unit (CPU) 160 (which is a separate entity from the central processing units 130 in FIG. 4), memory 161 (such as random-access memory (RAM) on a double data rate (DDR) bus), firmware 162 on a flash memory (such as an embedded multi-media card (eMMC) flash memory or a serial peripheral interface (SPI) flash memory), and a root of trust (RoT) chip 164. The BMC 150 further includes a wide variety of input/output ports. For example, the input/output (I/O) ports may include I/O ports 165 to the hardware components of the server, such as a Platform Environment Control Interface (PECI) port and/or an Advanced Platform Management Link (APML) port; I/O ports 166 to the hardware components of the servers and/or a network interface controller (NIC), such as a Peripheral Component Interconnect Express (PCIe) port; I/O ports 167 to the NIC, such as a network controller sideband interface (NC-SI) port; and I/O ports 168 to a network that accessible to an external user, such as an Ethernet port. The BMC 150 may use any one or more of these I/O ports to interact with hardware devices installed on the server for purposes of monitoring and control.

FIG. 4 is a flowchart of operations 170 performed by a processor of a baseboard management controller according to some embodiments. Operation 172 includes receiving a message from Unified Extensible Firmware Interface code on a first computing node, wherein the message identifies a hardware device installed within the first computing node for which the Unified Extensible Firmware Interface code is missing driver code, and wherein the Unified Extensible Firmware Interface code is unable to initialize the hardware device to an operating system of the first computing node without the missing driver code. Operation 174 includes sending a prompt to a driver code generating service requesting the driver code generating service generate new driver code for the identified hardware device, wherein the driver code generating service includes a large language model for generating new driver source code and a code compiler for compiling the new driver source code to form new driver binary code. Operation 176 includes receiving the new driver binary code from the driver code generating service. Operation 178 includes causing the new driver binary code to be loaded into the Unified Extensible Firmware Interface code, wherein the Unified Extensible Firmware Interface code is able to use the new driver binary code to initialize the hardware device to the operating system.

FIG. 5 is a flowchart of operations 180 performed by a driver code generating service according to some embodiments. Operation 182 includes loading a large language model that has been trained to generate driver source code for use by Unified Extensible Firmware Interface code to initialize a hardware device within a computing node. Operation 184 includes receiving a prompt requesting driver source code for an identified hardware device. Operation 186 includes causing the trained large language model to generate the driver source code for the identified hardware device.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-transitory computer readable storage medium and program instructions embodied therein, the program instructions being configured to be executable by a processor of a management controller in a server to cause the processor to perform operations comprising:
receiving a message from Unified Extensible Firmware Interface code on a first computing node, wherein the message identifies a hardware device installed within the first computing node for which the Unified Extensible Firmware Interface code is missing driver code, and wherein the Unified Extensible Firmware Interface code is unable to initialize the hardware device to an operating system of the first computing node without the missing driver code;
sending a prompt to a driver code generating service requesting the driver code generating service generate new driver code for the identified hardware device, wherein the driver code generating service includes a large language model for generating new driver source code and a code compiler for compiling the new driver source code to form new driver binary code;
receiving the new driver binary code from the driver code generating service; and
causing the new driver binary code to be loaded into the Unified Extensible Firmware Interface code, wherein the Unified Extensible Firmware Interface code is able to use the new driver binary code to initialize the hardware device to the operating system.

2. The computer program product of claim 1, the operations further comprising:
sending a prompt to a local source code database searching for the missing driver code;
downloading, in response to the local source code database having matching driver code for the hardware device, the matching driver code from the local source code database; and
causing the matching driver code to be loaded into the Unified Extensible Firmware Interface code, wherein the Unified Extensible Firmware Interface code is able to use the matching driver code to initialize the hardware device to the operating system.

3. The computer program product of claim 2, wherein the prompt to the driver code generating service is sent in response to the local source code database not having matching driver code for the hardware device.

4. The computer program product of claim 1, wherein the management controller is a baseboard management controller.

5. A method comprising:
a management controller receiving a message from Unified Extensible Firmware Interface code on a first computing node, wherein the message identifies a hardware device installed within the first computing node for which the Unified Extensible Firmware Interface code is missing driver code, and wherein the Unified Extensible Firmware Interface code is unable to initialize the hardware device to an operating system of the first computing node without the missing driver code;
the management controller sending a prompt to a driver code generating service requesting the driver code generating service generate new driver code for the identified hardware device, wherein the driver code generating service includes a large language model for generating new driver source code and a code compiler for compiling the new driver source code to form new driver binary code;
the management controller receiving the new driver binary code from the driver code generating service; and
the management controller causing the new driver binary code to be loaded into the Unified Extensible Firmware Interface code, wherein the Unified Extensible Firmware Interface code is able to use the new driver binary code to initialize the hardware device to the operating system.

6. The method of claim 5, further comprising:
the management controller sending a prompt to a local source code database searching for the missing driver code;
the management controller downloading, in response to the local source code database having matching driver code for the hardware device, the matching driver code from the local source code database; and
the management controller causing the matching driver code to be loaded into the Unified Extensible Firmware Interface code, wherein the Unified Extensible Firmware Interface code is able to use the matching driver code to initialize the hardware device to the operating system.

7. The method of claim 6, wherein the prompt to the driver code generating service is sent by the management controller in response to the local source code database not having matching driver code for the hardware device.

8. The method of claim 5, wherein the management controller is a baseboard management controller.

9. The method of claim 5, further comprising:
the Unified Extensible Firmware Interface code ignoring an error or warning resulting from executing the new driver binary code in response to detecting that the new driver binary code was generated by the large language model.

10. A computer program product comprising a non-transitory computer readable storage medium and program instructions embodied therein, the program instructions being configured to be executable by a processor to cause the processor to perform operations comprising:
loading a large language model that has been trained to generate driver source code for use by Unified Extensible Firmware Interface code to initialize a hardware device within a computing node;
receiving a prompt requesting driver source code for an identified hardware device;
causing the trained large language model to generate driver source code for the identified hardware device.

11. The computer program product of claim 10, the operations further comprising:
creating the trained large language model by training an AI model to generate the driver source code, wherein the AI model is trained using datasets including:
datasheets and reference manuals of a plurality of an integrated circuits that require a driver;
reference code from one or more vendor of hardware devices used in computing nodes;
driver source code for a plurality of hardware devices used in computing nodes;
driver source code from the same vendor, but for other hardware components; and
a Unified Extensible Firmware Interface Development Kit codebase including an EFI driver model and driver code structure.

12. The computer program product of claim 10, the operations further comprising:
storing, for each of a plurality of instances of driver source code generated by the large language model, the generated driver source code in association with an identifier for a device that submitted the prompt requesting the driver source code;
receiving feedback from the device that submitted the prompt indicating that the generated driver source code did not enable initialization of the hardware device; and
causing the large language model to regenerate the driver source code.

13. The computer program product of claim 12, wherein the large language model regenerates the drive source code using different prompt values than in the received prompt.

14. The computer program product of claim 12, the operations further comprising:
retraining the large language model in response to receiving the feedback, wherein the large language model regenerates the driver source code subsequent to the retraining of the large language model.

15. The computer program product of claim 10, the operations further comprising:
providing the generated driver source code to a code compiler for compiling the generated driver source code to form generated driver binary code.

16. The computer program product of claim 10, wherein the large language model is loaded in a cloud-computing environment to establish a driver code service.

17. The computer program product of claim 10, wherein the large language model generates the driver source code including a first code portion that implements fully functionality for a first subset of capabilities of the hardware device and a second code portion that implements stub functionality for a second subset of capabilities of the hardware device.

18. The computer program product of claim 10, wherein the large language model generates the driver source code including a code portion that provides stub functionality for one or more capabilities of the hardware device while enabling the computing node to boot.

19. The computer program product of claim 15, the operations further comprising:
sending the driver binary code to a management controller of a computing device, wherein the management controller sent the prompt requesting driver source code for the identified hardware device.

20. The computer program product of claim 15, the operations further comprising:
sending the driver binary code and/or the drive source code to a code database to be stored in association with the identity of the hardware device.
